(19) United States
(12) Patent Application Publication
(10) Pub. No.: US 2025/0349289 A1
(43) Pub. Date: Nov. 13, 2025

(54) Abridged Multilingual Speech Models For Automatic Speech Recognition

(71) Applicant: Oracle International Corporation, Redwood Shores, CA (US)

(72) Inventors: Amin Abdaoui, Toulouse (FR); Serge Le Huitouze, Rennes (FR); Abdelmoumene Boumadane, Paris (FR); Romain Lebarbenchon, Rennes (FR)

(73) Assignee: Oracle International Corporation, Redwood Shores, CA (US)

(21) Appl. No.: 18/662,550

(22) Filed: May 13, 2024

(51) Int. Cl. G10L 15/183; G10L 15/00

(52) U.S. Cl. CPC G10L 15/183; G10L 15/005

(57) ABSTRACT

Techniques are disclosed herein for an automatic speech recognition system. Tokens are selected for a particular language or script while other tokens not used by the particular language or script are removed from the ASR vocabulary. Numerical tokens and tokens that are special tokens for the underlying ASR model of the system are also selected. Tokens that have a reading direction different than the particular language or script are removed. Rows are removed from an embedding matrix for the ASR model corresponding to the removed tokens. Similarly, the final token classification layer is adjusted using the selected tokens. The subset of tokens, the embedding matrix with rows removed and the adjusted classification layer are used to generate language specific models from a multilingual speech model. The language specific models are stored and used for generating a transcript in target languages or scripts.

### TECHNICAL FIELD

The present disclosure relates to automatic speech recognition. In particular, the present disclosure relates to generating a transcript of speech in a particular language or script.

### BACKGROUND

Automatic speech recognition (ASR), sometimes referred to as speech-to-text (STT), is a set of computer technologies used to convert spoken language into text, without requiring human interpreters. ASR allows computers to understand and interpret human speech, making it possible to interact with devices using voice commands, to transcribe spoken words into text documents, or to support features like voice search and virtual assistants. Speech recognition systems typically process audio signals, analyze the acoustic features of speech, and apply language models and algorithms to convert the audio input into text output.

ASR models have grown significantly in size along with advancements in deep learning and increasingly large datasets. Modern ASR models often include deep neural networks with millions or even billions of parameters. These large models are trained on vast amounts of annotated speech data, to help improve their accuracy across various languages and speech conditions. However, their size also poses challenges in terms of computational resources and energy consumption. For example, larger models require more network bandwidth and other resources to transfer between devices. Larger models also require more storage space, which may be a limiting factor, for example, when attempting to add language recognition to portable and/or embedded devices with relatively little storage space.

Multilingual models in ASR aim to process and understand speech in any of multiple languages. Multilingual models leverage techniques like transfer learning and shared representations to handle multiple languages within a single model. This approach improves efficiency and reduces the need for language-specific resources. Multilingual ASR models face unique challenges due to the diversity between the multiple languages (and/or multiple scripts) the model aims to understand and due to the even greater size of such models as compared to single-language or single-script models.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for abridging a multilingual ASR model based automatic speech recognition, in accordance with one or more embodiments;

FIGS. 3a-c illustrate an example of abridging a multilingual ASR model, in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. SYSTEM ARCHITECTURE
3. ABRIDGING A MULTILINGUAL ASR MODEL
4. EXAMPLE OF ABRIDGING A MULTILINGUAL ASR MODEL
5. COMPUTER NETWORKS AND CLOUD NETWORKS
6 MICROSERVICE APPLICATIONS
7. HARDWARE OVER VIEW
8. MISCELLANEOUS; EXTENSIONS

### 1. General Overview

Automatic Speech Recognition (ASR) systems are used to convert spoken language into written text automatically. ASR systems work by analyzing audio data input, typically in the form of spoken words or phrases that are recorded and/or stored in a digital audio format, and then using algorithms to transcribe that speech into text. ASR systems are used in many different applications.

Multilingual ASR models for ASR provide powerful capabilities, but face certain challenges related to their size and related to language diversity. Multilingual ASR models accommodate vocabulary, phonetic, and syntactic variations across multiple languages, which results in larger model sizes and increased computational complexity compared to single-language models. Larger models require more memory and computational resources for both training and inference, which can pose challenges for deployment on resource-constrained devices or in real-time applications.

Training and fine-tuning multilingual ASR models require substantial computational resources, as they need to process and learn from vast amounts of multilingual speech data. This can be particularly challenging for researchers and organizations with limited access to computational infrastructure or specialized expertise in multilingual machine learning.

Multilingual ASR models may encounter difficulties in accurately determining the language being spoken, especially in situations where speakers switch between languages and/or speak with a heavy accent. Errors in language detection can lead to suboptimal performance or misinterpretation of speech content. This problem becomes more pronounced in regions with significant linguistic diversity or where multiple languages are commonly spoken interchangeably. Multilingual environments often present challenges related to ambiguity, where speech utterances contain words or phrases that are common across multiple languages. In such cases, multilingual ASR models may struggle to accurately identify the intended language context, resulting in errors or inconsistencies in transcription. Multilingual ASR models may compromise on language-specific optimization strategies in favor of accommodating multiple languages within a unified framework. As a result, performance optimizations tailored to specific languages may be underutilized, leading to suboptimal performance for individual languages within the multilingual context.

By reducing the number of total tokens in the vocabulary of an ASR model, such as by abridging a multilingual ASR model to obtain an abridged ASR model that is language-specific and/or script-specific, a smaller ASR model can be obtained without significant loss of performance in most cases, and rather with improved performance in many cases. Limiting the vocabulary to less tokens, such as by limiting to a particular script or language, reduces the model size and reduces computational complexity. Selectively retaining and removing numerical tokens, special tokens and/or misdirected tokens can further optimize the number of tokens. This can lead to faster inference times, lower resource requirements, and more accurate results, making the model more efficient and effective to deploy and use. Additionally, limiting the vocabulary to less tokens reduces language hallucination by the model (e.g. predicting Chinese tokens when transcribing English speech).

One or more embodiments start from an existing multilingual ASR model and reduce its size by eliminating portions that aren't needed for a specific script and/or language. Specifically, one or more embodiments access a multilingual ASR model that includes a token embedding matrix corresponding to multiple language tokens. The language tokens include subsets of language tokens associated with different languages. One or more embodiments generate a language-specific ASR model for one of those languages (the “target” language), at least by (a) retaining, from the multilingual ASR model, a portion of the embedding matrix corresponding to a subset of language tokens associated with the target language, and (b) removing, from the multilingual ASR model, a portion of the embedding matrix corresponding to a subset of language tokens associated with one or more non-target languages. In one or more embodiments, one or more such language-specific ASR models are generated from the multi-lingual model. Once the language-specific ASR models are generated, these models can be reused for tasks related to the specific language for the model. Similar script-specific models are used to obtain a transcript of the digital audio input in a target script. In various embodiments, language-specific ASR models are specific to one language or to a set of languages that is a subset of the languages associated with the multilingual ASR model. In embodiments, tokens corresponding to a language or script not used by the language(s) of the language-specific model are removed from the model vocabulary. Alternatively, tokens corresponding to a language or script not used by the language(s) of the language-specific model are masked at runtime.

Various embodiments also include systems, methods, and media for executing the operations. Various embodiments described further in this Specification and/or recited in the claims may or may not be included in this General Overview section.

### 2. System Architecture

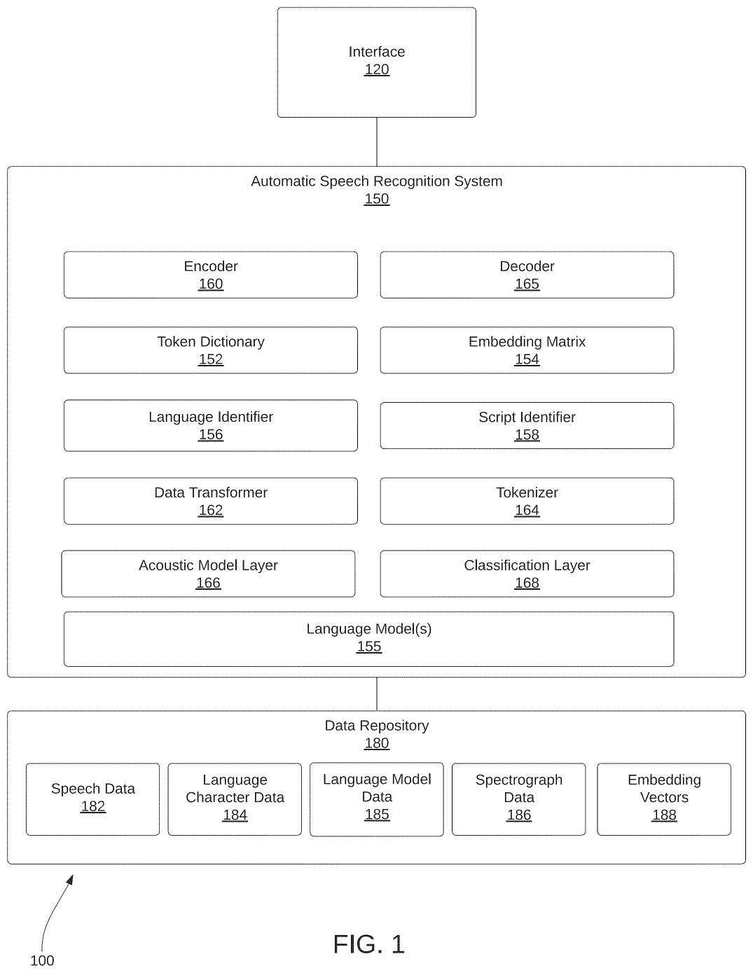

FIG. 1 illustrates a system 100 in accordance with one or more embodiments. As illustrated in FIG. 1, the system 100 includes an interface 120, an automatic speech recognition (ASR) system 150, and a data repository 180, each of which may include various subcomponents. Each of these components is described in further detail below.

In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In an embodiment, the ASR system 150 includes a language model 155, an encoder 160, and a decoder 165. The ASR system 150 also includes a token dictionary 152, an embedding matrix 154, a language identifier 156, a script identifier 158, a data transformer 162, and a tokenizer 164.

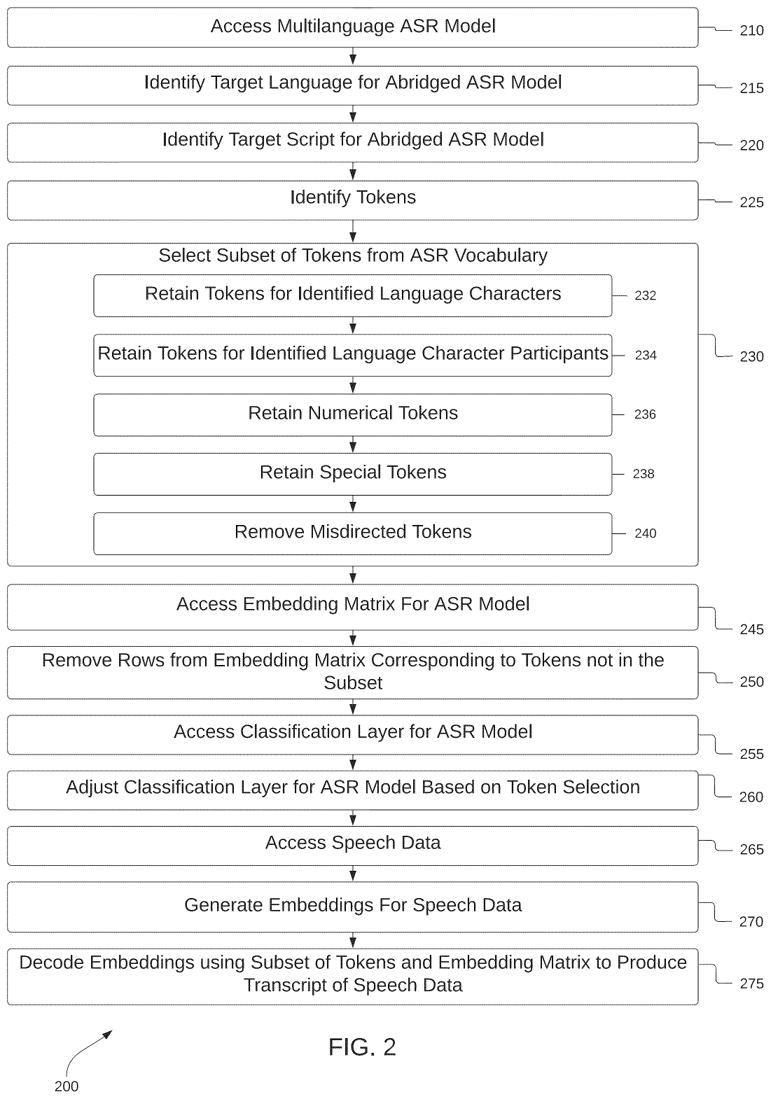

In one or more embodiments, the ASR system 150 refers to hardware and/or software configured to perform operations described herein for abridging a multilingual ASR model and/or performing automatic speech recognition using an abridged multilingual ASR model. Examples of operations for abridging multilingual ASR models for automatic speech recognition, and using abridged multilingual ASR models, are described below with reference to FIG. 2.

In an embodiment, the ASR system 150 is configured to perform various operations for processing spoken language. In various embodiments, language models are constructed using machine learning techniques, including convolutional neural networks (CNNs), recurrent neural networks (RNNs), long short-term memory (LSTM) architectures, transformer-based architectures, or other deep learning frameworks. ASR encompasses multiple stages, including modeling, encoding, and decoding language. Acoustic models establish the relationship between acoustic features of speech signals (such as Mel-frequency cepstral coefficients [MFCCs]) and phonemes or subword units, to identify the most probable sequence for input audio. Language modeling predicts the likelihood of word sequences in a given language, assisting in identifying the most probable sequence of words contain in input audio to improve translation or transcription.

The encoder 160 and the decoder 165 are speech recognition model layers used by the ASR system 150. The encoder 160 processes input audio signals, and the decoder 165 generates a corresponding decoded output, for example a decoded series of characters or a textual transcript is generated from encoded input audio signals. Various encoder-decoder frameworks include Recurrent Neural Network Transducer (RNN-T) models, Connectionist Temporal Classification (CTC) Models, transformer-based Models, or attention-based models.

The encoder 160 is a neural network component that includes recurrent layers and is responsible for processing and transforming input data into a compressed or encoded representation. The encoder 160 is configured to capture essential features or patterns present in the input data and represent them in a lower-dimensional space, often referred to as a latent space or embedding space. The encoded representation generated by the encoder 160 is used as input to downstream tasks. The encoding may be a fixed-size vector or a sequence of vectors, depending on the architecture and design choices of the encoder.

In an embodiment, the decoder 165 is a neural network component that includes recurrent layers and takes the encoded representation produced by the encoder 160 and generates an output representation. The decoder 165's role is to reconstruct the input data from the encoded representation in textual form. The decoder 165 transforms the encoded representation back into a decoded representation, such as by transforming the encoded representations back into the original input space, generating new data samples from random latent vectors, and/or generating a transcription of the decoded representations. In embodiments, the decoded representation is a transcript of input audio that is transcribed in a particular language and/or script.

In an embodiment, the token dictionary 152 is a data structure that contains a mapping between tokens and their corresponding numerical representations (embeddings). Tokens represent words, subwords, characters, and/or other linguistic units used in natural language or speech processing tasks. The token dictionary 152 serves as a lookup table for converting tokens into embeddings and vice versa. In the case of a multilingual automatic speech recognition system, the token dictionary 152 includes tokens corresponding to words, subwords, characters, or other linguistic units that belong to different languages and/or different scripts. The token dictionary 152 also includes numerical tokens and special tokens. Numerical tokens represent numerals which may be used by multiple languages or scripts.

In embodiments, special tokens in various ASR system language models are used as placeholders to represent special symbols, entities, or conditions within the input or output sequences. These tokens serve various purposes and may be incorporated into the model architecture or into a training process to handle specific scenarios or improve performance. The following are types of special tokens used in ASR systems:
1. Padding Token: Padding tokens are used to pad input sequences to a fixed length during mini-batch training or inference. Padding tokens ensure that all input sequences have the same length, facilitating efficient batch processing in neural network architectures.
2. Start-of-Sequence (SOS) Token: A Start-of-Sequence token marks the beginning of an output sequence generated by a model. SOS tokens are used in sequence-to-sequence models to indicate the start of the decoding process.
3. End-of-Sequence (EOS) Token: An End-of-Sequence token signifies the end of an output sequence generated by a model and is appended to the output sequence to indicate the completion of the decoding process.
4. Mask Token: Mask tokens are used in attention mechanisms to indicate which elements of the input sequence should be attended to and which should be ignored. Mask tokens help models focus on relevant parts of the input sequence while suppressing irrelevant information.
5. Unknown Token: An Unknown token represents out-of-vocabulary (OOV) words or tokens that are not present in the vocabulary used during training. When a model encounters unknown words during inference, it replaces them with the unknown token to handle out-of-vocabulary terms gracefully; Special Tokens for Speaker Identification: In speaker-dependent ASR systems, special tokens may be used to represent speaker identifiers or speaker-related metadata. These tokens allow a model to recognize and adapt to individual speakers' speech characteristics, improving accuracy and performance.
6. Language and/or Script Identification Special Tokens: The ASR system 150 uses special tokens to represent language or script identifiers in multilingual or multiscript systems. These tokens determine the language or script of the input.

In an embodiment, an embedding matrix 154 is a two-dimensional matrix where each row represents the embedding vector for a specific token. Embedding vectors are encoded, denser, lower-dimensional representations (as opposed to raw audio) that include an array of values corresponding to values for attributes of a token. In the embedding matrix 154, an identifier column (for example the first column) may include headers or other token identifiers. A row in the embedding matrix for a token can be identified by matching the token to an entry in the identifier column or header of the embedding matrix. The embedding matrix 154 is used to convert token indices into vector representations that capture semantic similarities between tokens.

In an embodiment, a language identifier 156 is configured to determine the language of an input. The language identifier 156 analyzes various linguistic features to select a highest likelihood language for input audio that is processed by the language identifier 156. In some cases, a target language may be provided to the language identifier 156, and the language identifier 156 provides an identification of the target language to other components.

In an embodiment, a script identifier 158 is configured to determine the script of an input. As used herein, the term “script” refers to a particular set of symbols used to represent a particular language. The script identifier 158 analyzes various linguistic features to select a highest-likelihood script for input audio that is processed by the script identifier 158. In some cases, a target script may be provided to the script identifier 158, and the script identifier 158 provides an identification of the target script to other components.

In an embodiment, a data transformer 162 is configured to preprocess and/or transform raw input data into formats suitable for further processing by the encoder 160 and decoder 165. The data transformer 162 performs types of tasks including data cleaning, normalization, feature extraction, and augmentation. The data transformer 162 ensures that input audio data meets the requirements of downstream models or algorithms. The data transformer 162 also includes modules for transforming the output of the decoder 165 to a final format, for example for consumption by an end user or service.

In an embodiment, a tokenizer 164 is configured to segment or divide spoken language input into smaller linguistic units called tokens. Tokens represent meaningful units of speech, such as words, subwords, phonemes, or other linguistic entities. The tokenizer 164 includes modules that process the input speech data into tokens and prepare it for further processing by the ASR system. The tokenizer 164 segments data based on predefined rules or patterns, such as duration, power, silence, language-specific rules, or other rules, depending on the chosen tokenization strategy, which may vary depending on the specific ASR task, language, and domain. The tokenizer 164 utilizes the token dictionary 152 to determine the vocabulary or universe of known tokens, which may include words, subwords, or phonetic units. The tokenizer 164 determines an array of tokens corresponding to input audio data.

The tokenizer 164 may use special tokens to represent specific linguistic entities or conditions, such as padding tokens, start-of-sequence tokens, end-of-sequence tokens, and unknown tokens. These special tokens facilitate various aspects of ASR processing, such as sequence alignment, decoding, and handling out-of-vocabulary terms.

The acoustic model layer 166 processes input digital audio based on the frequency spectrum, amplitude, timbre, envelope, and/or other waveform features of the digital audio to map the sounds being produced to corresponding units such as phonemes, subwords, words, and/or other sound units based on a similarity between the sound and the corresponding unit.

The classification layer 168 assigns probabilities to tokens based on the input from the previous network layers. The tokens can be characters, sub-word units, or even words, depending on the model design. In various embodiments, the token dictionary 152, embedding matrix 158 and/or classification layer are adjusted and/or abridged versions with respect to a corresponding token dictionary, embedding matrix and/or classification layer of a multilingual speech model. The ASR system 150 uses a language model 155 that has been previously adjusted and/or abridged for a specific language and selects the language model 155 based on a target language matching the specific language for the language model 155.

In an embodiment, a data repository 180 includes various types of data for speech processing tasks. For example, the data repository 180 may include: speech data 182, which contains recordings of spoken language; language character data 184, which includes data related to characters, scripts, and languages used by the ASR system 150; language model data 185, which includes data specific to parameters, training, or behavior of the language model 155; spectrograph data 186, which includes audio content data in the form of spectrographs; and embedding vectors 188, which include embeddings describing attributes of audio content, portions of audio content, and/or relationships between portions of audio content.

Speech data 182 includes recordings of spoken language captured in the form of audio files. These audio recordings typically contain human speech uttered by speakers in various contexts, such as conversations, lectures, interviews, or broadcasts. Speech data 182 serves as the primary input to the ASR system 150, where it undergoes preprocessing, feature extraction, and analysis to convert spoken language into text.

Language character data 184 includes information related to characters, scripts, and languages used by the ASR system. This data encompasses the set of characters or graphemes present in the written form of languages supported by the ASR system 150. Language character data 184 also includes metadata about language-specific writing systems, such as alphabets, syllabaries, or logographic scripts, as well as information about language families, linguistic features, and language identification. Language character data 184 includes language-specific features, which are components to improve performance on tasks related to a particular language. For instance, models for languages with rich morphology may include mechanisms for handling inflectional and derivational morphology more effectively. Language character data 184 includes language-specific embeddings, including word embeddings or subword embeddings used to represent words or tokens as dense vectors that are trained on language-specific data. Language-specific embeddings can capture nuances and idiosyncrasies of the specific language, improving the model's understanding and generation capabilities.

Language model data 185 includes data specific to the language model 155, including data for training or for defining parameters or hyper parameters of the language model 155. The language model data 185 includes values tailored to the model architecture, training objectives, and/or intended applications. Various types of language model data 185 include:
1. Training Data: Language models are trained on vast amounts of data. Training data is general or specific to the language(s) the model is designed to understand and generate. Training data can include a wide range of text sources and audio sources.
2. Tokenization Rules: Language models tokenize input text into smaller units, such as words, subwords, or characters, to process them effectively. Tokenization rules may vary depending on the language and the specific tokenization strategy employed by the model. For example, languages with complex morphology or character-based scripts may require specialized tokenization rules.
3. Domain-specific Data: Language models may be fine-tuned or specialized for specific domains or topics, requiring domain-specific training data. For example, models for medical applications may be trained on medical literature and terminology, while models for legal tasks may be trained on legal documents and case law.
4. Language Model Architecture: The architecture of a language model, including the number of layers, the type of recurrent or attention mechanisms used, and other architectural choices, can influence its performance and behavior. Data specific to the model architecture may include parameters, weights, and configurations learned during training.
5. Task-specific Data: Language models may be trained or fine-tuned for specific tasks, such as text classification, language translation, or text generation. Task-specific data includes training examples, labels or targets, and any additional task-specific metadata required for training and evaluation.
6. Evaluation Data: Language models require evaluation data to assess their performance and generalizability. Evaluation data may include annotated datasets for tasks like language modeling, sentiment analysis, named entity recognition, and others. This data is used to measure metrics such as accuracy, precision, recall, scoring, and the like, during model development and testing.

Spectrogram data 186 represents audio content in the form of spectrograms, which are visual representations of the frequency content of an audio signal over time. Spectrograms display the intensity of different frequency components of the audio signal as a function of time, typically using a color scale to represent amplitude or power. The ASR system 150 uses spectrogram data 186 to make certain types of information more available for further processing, such as feature extraction to capture relevant information for speech or language recognition tasks.

Embedding vectors 188 are dense, low-dimensional representations of audio content, portions of audio content, or relationships between portions of audio content in a n-dimensional space. In the context of speech processing, embedding vectors 188 may represent various aspects of speech signals, such as phonetic content, speaker characteristics, or semantic meaning. Embedding vectors 188 are used in clustering, speaker recognition, speech recognition, speech synthesis, labeling, and other tasks. Embedding vectors 188 capture semantic or acoustic similarities between different audio segments or capture relevant attributes of audio content in a continuous vector space. Embedding vectors 188 are computed using various types of deep learning-based feature extraction techniques, where neural networks learn to encode meaningful features from raw audio signals.

In one or more embodiments, the data repository 180 is any type of storage unit and/or device (e.g., a file system, database, collection of tables, or any other storage mechanism) for storing data. Further, a data repository 180 may include multiple different storage units and/or devices. The multiple different storage units and/or devices may or may not be of the same type or located at the same physical site. Further, a data repository 180 may be implemented or executed on the same computing system as ASR system 150. Additionally, or alternatively, a data repository 180 may be implemented or executed on a computing system separate from ASR system 150. The data repository 180 may be communicatively coupled to ASR system 150 via a direct connection or via a network.

Data containing information used for abridging multilingual ASR models and/or for performing automatic speech recognition using abridged multilingual ASR models may be implemented across any of components within the system 100. However, data is illustrated within the data repository 180 for purposes of clarity and explanation.

Additional embodiments and/or examples relating to computer networks are described below in Section 4, titled “Computer Networks and Cloud Networks.”

One or more embodiments are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 120 refers to hardware and/or software configured to facilitate communications between a user and speech recognition system 150. Interface 120 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 120 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 120 is specified in one or more other languages, such as Java, C, or C++.

### 3. Abridging a Multilingual ASR Model

FIG. 2 illustrates an example set of operations 200 for abridging a multilingual ASR model for an automatic speech recognition system. In embodiments, Operations 200 are performed by a speech recognition system, such as automatic speech recognition system 150 of FIG. 1. One or more operations illustrated in FIG. 2 may be modified, rearranged, or omitted altogether. Accordingly, the particular sequence of operations illustrated in FIG. 2 should not be construed as limiting the scope of one or more embodiments.

As illustrated in FIG. 2, the system accesses a multilingual ASR model to be abridged (Operation 210). As discussed above, multilingual ASR models accommodate vocabulary, phonetic, and syntactic variations across multiple languages. However, a multilingual ASR model is typically considerably larger than a single-language model.

In an embodiment, the system identifies a target language for an abridged multilingual ASR model (Operation 215). The system may identify the target language based on user input and/or instructions that specify the target language. Alternatively or additionally, the system may identify a target language by analyzing an audio content file, or a portion of an audio content file, to determine a most-likely language that matches qualities of the recorded speech. Alternatively or additionally, the system may be configured to use a default target language for some or all audio content.

In an embodiment, the system identifies a target script for an abridged multilingual ASR model (Operation 220). The system may identify a target script based on user input and/or instructions that specify the target script. Alternatively or additionally, the system may identify a target script by analyzing an audio content file, or a portion of an audio content file, to determine the primary language in the audio content; the target script may be a default script for the language detected in the audio content.

In an embodiment, the system identifies tokens in the multilingual ASR model (Operation 225). Specifically, the multilingual ASR model includes one or more libraries or dictionaries of tokens. The system identifies the tokens as those that are included in a library or dictionary of the ASR model that is used to generate embeddings for input speech and/or decode embeddings to transcribe the input speech.

In an embodiment, the system selects a subset of tokens, from the identified tokens, to retain in the abridged multilingual ASR model (Operation 230). In various embodiments, the system retains a subset of tokens corresponding to one or more particular scripts and/or one or more particular languages.

Selecting the subset of tokens from the identified tokens may include retaining tokens for language characters of the identified language (Operation 232). Language characters used in the identified language are included in the subset. Language characters not used in the identified language are excluded from the subset of tokens.

Selecting the subset of tokens from the identified tokens may include retaining tokens for language character participants of the identified language (Operation 234). Language character participants used in the identified language are included in the subset. Language character participants not used in the identified language are excluded from the subset of tokens. Language characters may include multiple language character participants that together form the characters or participate in forming the character. In some cases, selected tokens correspond to character participants rather than characters.

Selecting the subset of tokens from the identified tokens may include retaining numerical tokens (Operation 236). In embodiments, numerical tokens are included in the subset regardless of identified language. Numerical tokens can be excluded from the subset based on having a misdirected read direction and/or corrected by changing a read direction for the numerical tokens to a read direction of an identified language.

Selecting the subset of tokens from the identified tokens may include retaining special tokens (Operation 238). In embodiments, special tokens are included in the subset regardless of identified language. In embodiments, special tokens that are language-specific to a language other than the target language are excluded from the subset. In embodiments, special tokens that are specific to a selected ASR model are retained in the subset of tokens and special tokens that are specific to a different ASR model are removed from the subset of tokens.

Selecting the subset of tokens from the identified tokens may include removing misdirected tokens that are misdirected relative to the identified language (Operation 240). Identified languages (or identified scripts) have a reading direction defined by the direction in which the identified language is read (e.g. left-to-right, right-to-left, top-to-bottom, etc.). Language tokens that have a reading direction different than the selected language (or script) are excluded from the subset. Thus, tokens corresponding to a language (or script) other than the identified language (or script) are removed from the token dictionary for the ASR model to result in an abridged token dictionary. The abridged token dictionary is used as part of an abridged ASR model. The abridged ASR model is a reduced in the number of languages and/or scripts as opposed to an unabridged ASR model.

The system accesses an embedding matrix for the multilingual ASR model (Operation 245). The embedding matrix is used by the multilingual ASR model to map tokens to attributes or characteristics of speech embeddings which are determined using one or more of various feature extraction techniques. The extracted features are stored as feature values of an array of feature values for a token in a row of the embedding matrix that is headed by a header for the token. In embodiments, the feature values are previously determined by training or fine-tuning of the multilingual ASR model and stored in a matrix of embeddings that is accessed by an ASR system utilizing the multilingual ASR model.

The system removes rows from the embedding matrix corresponding to tokens not in the subset of tokens (Operation 250). The system retains rows having a header matching a token in the subset of tokens. The system excludes or removes rows having a header matching a token that has been excluded from the subset of tokens. Thus, rows corresponding to a language (or script) other than the identified language (or script) are removed from the embedding matrix for the multilingual ASR model to result in an abridged embedding matrix. The abridged embedding matrix is used for an abridged ASR model. The abridged ASR model is a reduced in the number of languages and/or scripts as opposed to an unabridged ASR model.

The system accesses a classification layer of the multilingual ASR model (Operation 255). The example multilingual ASR models include classification layers that the system accesses. The classification layer includes a learning framework, such as a neural network or other learning framework. The learning framework has an output domain which includes token output.

The system modifies the classification layer of the ASR model (Operation 260) based on the tokens that are selected and/or removed from the unabridged set of tokens used by the multilingual ASR model. The system removes a token from the classification layer by modifying the architecture of the learning framework of the classification layer to reduce the dimensionality of the output. In embodiments, rows of matrices used by the learning framework that are associated with the removed tokens are deleted from the matrices used by the learning framework. Alternatively, weights associated with the removed tokens are set to zero. In some embodiments, a decoder of the system is adjusted to set a probability associated with the token to zero (0). In some embodiments, the system retrains a language-specific model to learn distributions of the remaining tokens after a particular token is removed from the classification layer and/or after the decoder is adjusted. The adjusted classification layer is used as the classification layer of the language-specific model.

In this way, an abridged ASR model is generated according to operations 210-260. One or more language-specific ASR models are generated by abridging the multilingual models based on a specified language or script. These models are preserved for later use. When audio data is received by the system at a later runtime, the system identifies a target language and a language-specific model that has been stored. Once one or more language-specific abridged models are generated and stored, the system uses the one or more models to transcribe speech data accessed by the system. In some cases, a language specific model is generated in response to receipt of audio data in a target language for which a model is not present in the system.

The system accesses speech data (Operation 265). the speech data is accessed and transcribed in the target language and/or script according to operations 265-275. Speech data is accessed from types of sources including local data, remote data, repository data, and/or other sources of data by transferring or loading the speech data into memory. The speech data received by the system is transformed by a data transformer, processed by another component, and/or provided to an ASR encoder.

The system generates embeddings for the speech data (Operation 270). For example, an encoder of an ASR model receives input audio and generates encodings for the audio. Generating the encoding can be achieved transforming the raw audio waveform into a compact encoded vector representation that captures the essential characteristics in an embedding of the speech signal by extracting features of the speech signal into the compact representation using various techniques. The embeddings include feature values in arrays for discrete portions of speech in the speech data.

In an embodiment, the system uses the abridged ASR model to transcribe speech data (Operation 275). The system decodes embeddings using the subset of tokens and using the embedding matrix with rows removed to produce a transcript of the speech data. The system uses the embedding matrix to map portions of the audio data to tokens based on the attributes of the portions of the audio data being similar to the attributes for corresponding token. The transcript will be in the identified language (or script).

Once the transcript is generated, it can be further analyzed for various purposes such as sentiment analysis, topic modeling, or extracting insights from the conversation, and/or one or more other actions can be performed. Using the abridged ASR model reduces errors in transcription results while requiring less computational and storage resources as compared to the multilingual model.

### 4. Example of Abridging a Multilingual ASR Model

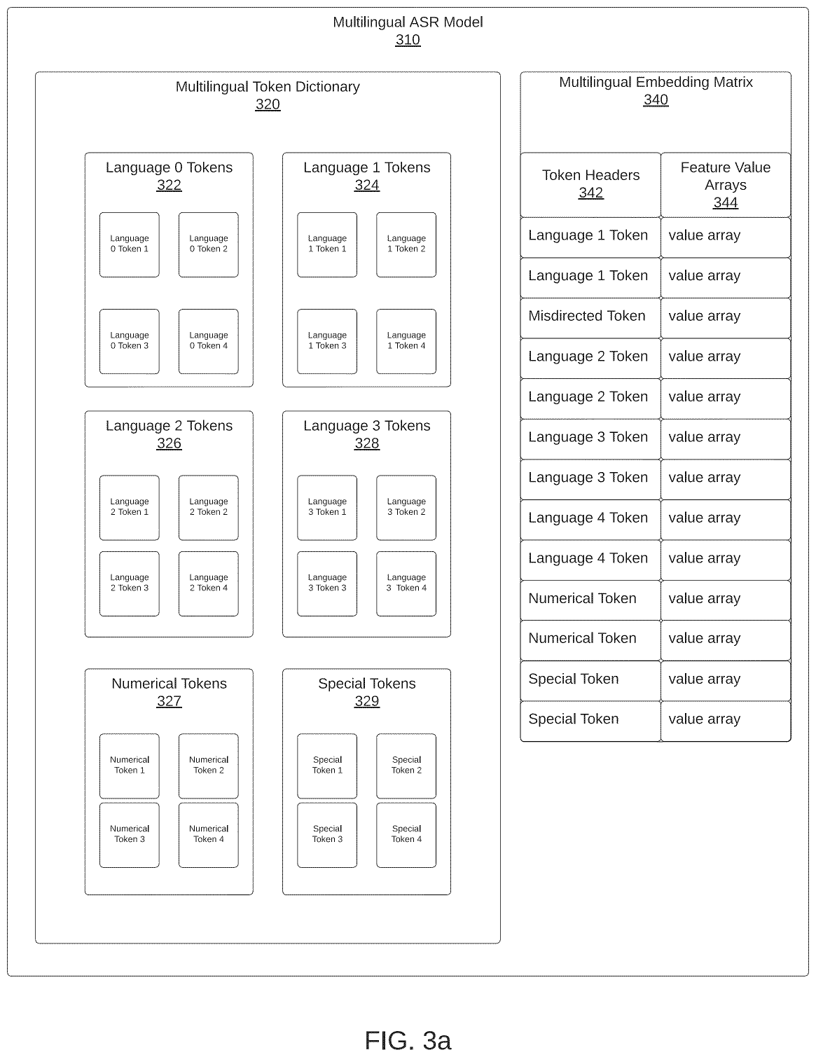

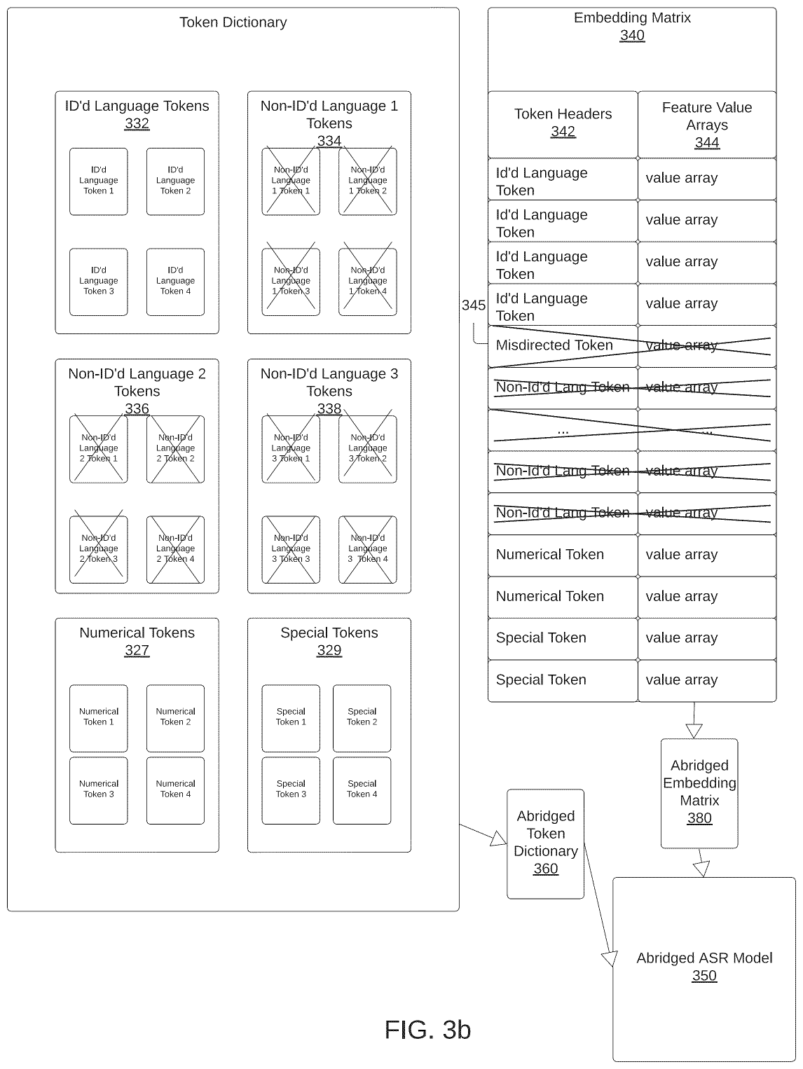

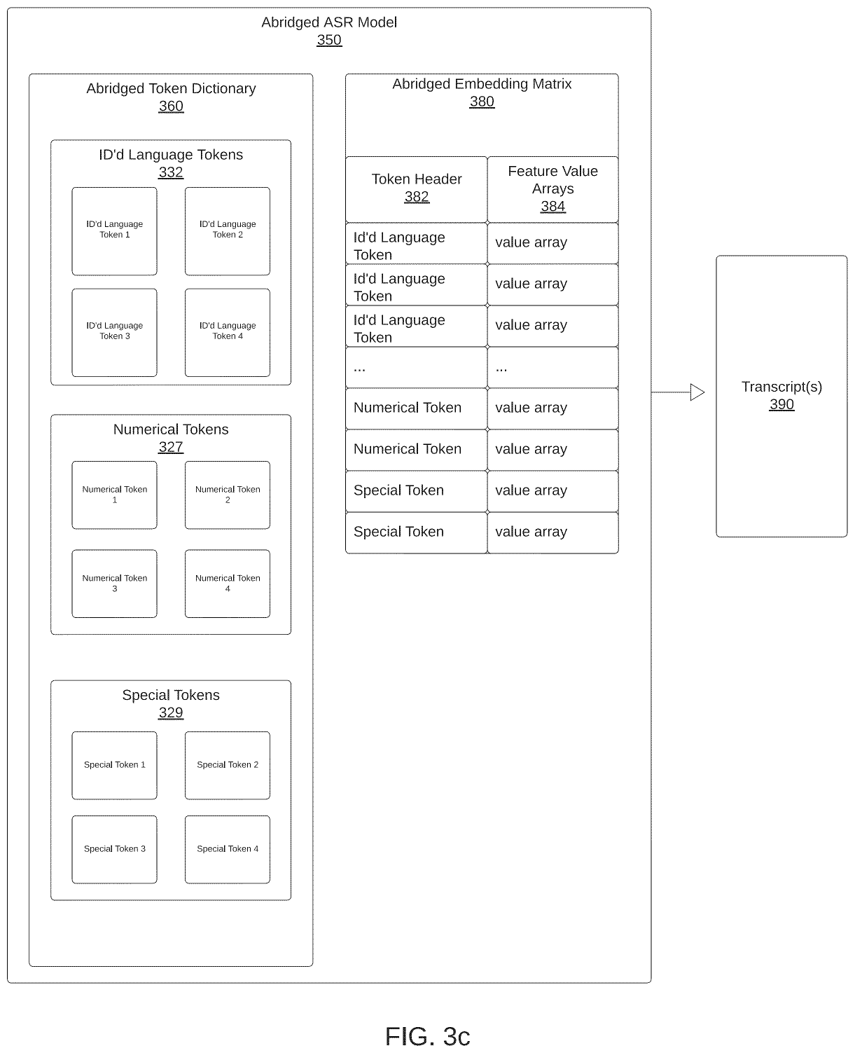

FIGS. 3a-c illustrate an example of abridging a multilingual ASR model 310 of an ASR platform 300, in accordance with one or more embodiments.

In the example of FIGS. 3a-c, speech data is received at an ASR platform 300. Rather than the multilingual ASR model 310 being used to transcribe the speech data, an abridged ASR model 350 is used to transcribe the speech data.

FIG. 3a illustrates a multilingual token dictionary 320 and a multilingual embedding matrix 340 of the multilingual ASR model 310. In FIG. 3a, the token dictionary 320 includes tokens from multiple languages (i.e., language 0 token 322, language 1 tokens 324, language 2 tokens 326, and language 3 tokens 328). The multilingual token dictionary 320 also includes numerical tokens 327 and/or special tokens 329. In embodiments, the token dictionary 320 also tokens from multiple scripts.

In FIG. 3a, the multilingual embedding matrix 340 includes rows corresponding to tokens of the multilingual token dictionary 320. Although the illustration shows a particular number of row, the embedding matrix can consist of any number of rows corresponding to any number of tokens. The first column of a row includes a token header 342 identifying the token for which the row corresponds. The second columns of the rows include arrays of feature values 344 corresponding to features or attributes of the token. Alternatively, the values of such an array can be separated into individual columns for the values in the array.

FIG. 3b illustrates selectively retaining and/or removing tokens from the token dictionary 320 to select a subset of tokens and illustrates selectively retaining and/or removing rows from the embedding matrix 340 of the ASR model 310. In FIG. 3b, identified language tokens 332 of the identified language are selectively retained while non-identified language tokens of the other languages are excluded to define a subset of tokens. In the example of FIG. 3b, language 0 has been identified as the identified language. The identified language tokens 332 are retained in the subset of tokens. The non identified language 1 tokens 334, the non-identified language 2 tokens, the non-identified language 3 tokens 338 are excluded from the token dictionary.

The subset of token is used to define an abridged dictionary 360 for the abridged ASR model 350. In FIG. 3b, rows of the embedding matrix 340 corresponding to the selected subset of tokens are selectively retained while rows corresponding to language tokens not in the identified language are removed and/or excluded to define an abridged embedding matrix 380 used for the ASR model 350. In embodiments, a script is identified instead of a language, language tokens for characters or character participants of the script are selectively retained and/or removed from the multilingual ASR dictionary 320 to define the abridged dictionary 360 and the abridged embedding matrix 380. In embodiments, the token header 342 is used to identify rows corresponding to tokens that are selectively retained or removed to define the abridged embedding matrix 380.

In FIG. 3b, a misdirected token 345 is removed from the multilingual token dictionary 320 based on having a reading direction different from the identified language or script. For example, tokens having a right-to-left reading direction are excluded from a subset of tokens of the multilingual token dictionary 320 used to generate the abridged token dictionary 360. Misdirected tokens are the result of proper nouns, names, or other direction inconsistencies resulting from variations in languages of the multilingual ASR model. A misdirected language token can also be the result of a language for a token using a different reading direction than an identified language.

FIG. 3c illustrates the abridged ASR model 350 including the abridged token dictionary 360 and the abridged embedding matrix 380. As shown, the token dictionary 360 includes the identified language tokens 332, the numerical tokens 327, and the special tokens 329. The abridged embedding matrix 380 includes rows having token headers 382 corresponding to the tokens in the abridged token dictionary 360. The rows include feature value arrays 384 providing arrays of feature values for the selected tokens. The abridged ASR model 350 is used by the ASR platform to process speech data to generate transcripts 390 in the identified language or script. In most cases, the abridged ASR model 350 provides more accurate results for the identified language or script and uses less resources than the multilingual ASR model 310.

In some embodiments, one or more tokens are tokens belonging to more than one language or script. In various embodiments, tokens belonging to more than one language are removed from the multilingual ASR dictionary 320 to define the abridged dictionary 360. In other embodiments, tokens belonging to more than one language are not removed from the multilingual ASR dictionary 320 to define the abridged dictionary 360 if one or more of the languages is the identified language.

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

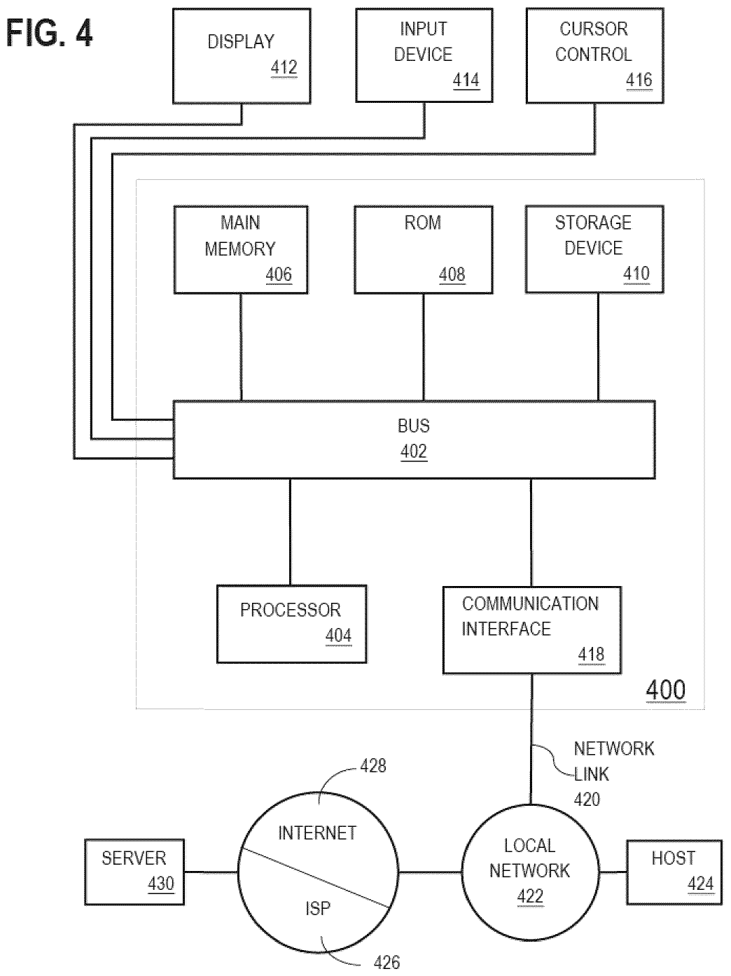

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 440 might transmit a requested code for an application program through Internet 428, ISP 426, local network 422 and communication interface 418.

The received code may be executed by processor 404 as it is received, and/or stored in storage device 410, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media storing instructions which, when executed by one or more hardware processors, cause performance of operations comprising:
accessing a multilingual automatic speech recognition (ASR) model comprising a token embedding matrix corresponding to a plurality of language tokens, wherein the plurality of language tokens comprises at least (a) a first subset of language tokens associated with a first language and (b) a second subset of language tokens associated with a second language;
generating a language-specific ASR model for the first language, at least by:
retaining, from the multilingual ASR model, a first portion of the embedding matrix corresponding to the first subset of language tokens associated with the first language;
removing, from the multilingual ASR model, a second portion of the embedding matrix corresponding to the second subset of language tokens associated with the second language;
applying a digital audio input, comprising spoken language in the first language, to the language-specific ASR model, to obtain a transcript of the digital audio input in the first language.

2. The one or more media of claim 1, wherein the first subset of language tokens associated with the first language comprises tokens associated with a particular language script.

3. The one or more media of claim 1, wherein generating the language-specific ASR model further comprises:
retaining, from the multilingual ASR model, a third portion of the embedding matrix corresponding to numerical characters.

4. The one or more media of claim 1, wherein generating the language-specific ASR model further comprises:
retaining, from the multilingual ASR model, a third portion of the embedding matrix corresponding to special characters used to direct operation of the multilingual ASR model.

5. The one or more media of claim 1, the operations further comprising:
identifying the first subset of language tokens associated with the first language, at least by tokenizing a corpus of text written in the first language.

6. The one or more media of claim 1, wherein generating the language-specific ASR model for the first language further comprises defining a classification layer of the language-specific ASR model according to an adjusted classification layer of the multilingual ASR model that is adjusted based on having the second subset of language tokens removed.

7. The one or more media of claim 1, the operations further comprising:
identifying the second subset of language tokens as tokens having a token reading direction different from a reading direction of the first language.

8. A system comprising:
one or more hardware processors;
one or more non-transitory computer-readable media; and
program instructions stored on the one or more non-transitory computer readable media which, when executed by the one or more hardware processors, cause the system to perform operations comprising:
accessing a multilingual automatic speech recognition (ASR) model comprising a token embedding matrix corresponding to a plurality of language tokens, wherein the plurality of language tokens comprises at least (a) a first subset of language tokens associated with a first language and (b) a second subset of language tokens associated with a second language;
generating a language-specific ASR model for the first language, at least by:
retaining, from the multilingual ASR model, a first portion of the embedding matrix corresponding to the first subset of language tokens associated with the first language;
removing, from the multilingual ASR model, a second portion of the embedding matrix corresponding to the second subset of language tokens associated with the second language;
applying a digital audio input, comprising spoken language in the first language, to the language-specific ASR model, to obtain a transcript of the digital audio input in the first language.

9. The system of claim 8, wherein the first subset of language tokens associated with the first language comprises tokens associated with a particular language script.

10. The system of claim 8, wherein generating the language-specific ASR model further comprises:
retaining, from the multilingual ASR model, a third portion of the embedding matrix corresponding to numerical characters.

11. The system of claim 8, wherein generating the language-specific ASR model further comprises:
retaining, from the multilingual ASR model, a third portion of the embedding matrix corresponding to special characters used to direct operation of the multilingual ASR model.

12. The system of claim 8, the operations further comprising:
identifying the first subset of language tokens associated with the first language, at least by tokenizing a corpus of text written in the first language.

13. The system of claim 8, wherein generating the language-specific ASR model for the first language further comprises defining a classification layer of the language-specific ASR model according to an adjusted classification layer of the multilingual ASR model that is adjusted based on having the second subset of language tokens removed.

14. The system of claim 8, the operations further comprising:
identifying the second subset of language tokens as tokens having a token reading direction different from a reading direction of the first language.

15. A method comprising:
accessing a multilingual automatic speech recognition (ASR) model comprising a token embedding matrix corresponding to a plurality of language tokens, wherein the plurality of language tokens comprises at least (a) a first subset of language tokens associated with a first language and (b) a second subset of language tokens associated with a second language;
generating a language-specific ASR model for the first language, at least by:
retaining, from the multilingual ASR model, a first portion of the embedding matrix corresponding to the first subset of language tokens associated with the first language;
removing, from the multilingual ASR model, a second portion of the embedding matrix corresponding to the second subset of language tokens associated with the second language;
applying a digital audio input, comprising spoken language in the first language, to the language-specific ASR model, to obtain a transcript of the digital audio input in the first language,
wherein the method is performed by at least one device including a hardware processor.

16. The method of claim 15, wherein the first subset of language tokens associated with the first language comprises tokens associated with a particular language script.

17. The method of claim 15, wherein generating the language-specific ASR model further comprises:
retaining, from the multilingual ASR model, a third portion of the embedding matrix corresponding to numerical characters.

18. The method of claim 15, wherein generating the language-specific ASR model further comprises:
retaining, from the multilingual ASR model, a third portion of the embedding matrix corresponding to special characters used to direct operation of the multilingual ASR model.

19. The method of claim 15, the method further comprising:
identifying the first subset of language tokens associated with the first language, at least by tokenizing a corpus of text written in the first language.

20. The method of claim 15, wherein generating the language-specific ASR model for the first language further comprises defining a classification layer of the language-specific ASR model according to an adjusted classification layer of the multilingual ASR model that is adjusted based on having the second subset of language tokens removed.
